(19) United States
(12) Patent Application Publication
(10) Pub. No.: US 2026/0087633 A1
(43) Pub. Date: Mar. 26, 2026

(54) AUTOMATIC IMAGE CROPPING USING GENERATIVE ARTIFICIAL INTELLIGENCE

(71) Applicant: Adobe Inc., San Jose, CA (US)

(72) Inventors: Ashish CHOPRA, Delhi (IN); Vangala Naveen REDDY, Hyderabad (IN)

(21) Appl. No.: 18/893,571

(22) Filed: Sep. 23, 2024

(51) Int. Cl. G06T 7/10; G06F 3/0482; G06V 10/25

(52) U.S. Cl. CPC G06T 7/10; G06F 3/0482; G06V 10/25; G06T 2207/20132; G06V 2201/07

(57) ABSTRACT

Some aspects relate to technologies providing a framework for automatically cropping images. In accordance with some aspects, a list of objects that are present in at least on image of a set of images is generated and that list is combined with a list of desired objects obtained from a content brief. In some aspects, the items in this combined list is ranked and this ranked list is used to detect and rank regions within images of the set of images that correspond to the combined and ranked list. In some aspects, these detected and ranked regions are used to inform the image cropping.

### BACKGROUND

Adapting existing content to satisfy different criteria involves receiving the content, receiving the criteria, and adapting the content to conform to those criteria. One example of adapting content is to crop images to conform to certain image sizes and aspect ratios while preserving salient aspects of those images. Cropping images while preserving image details generates images that are more suitable for certain needs (e.g., for display using different application or devices) while still retaining the relevant content. This cropping poses various challenges including identifying salient parts of images, determining how to crop those images so that the size and aspect ratio criteria are satisfied while still maintaining those salient portions of the images, and resolving any conflict between the criteria. The problems are compounded when, for example, a large number of images are to be cropped while still maintaining the salient portions of all of those images.

### SUMMARY

Some aspects of the present technology relate to, among other things, systems and methods for cropping images according to different criteria (e.g., size or aspect ratio) while preserving salient features in the images. In accordance with some aspects of the technology described herein, a corpus of images is received, along with image size or shape criteria and a specification for which content in the images to is to be highlighted or preserved. Based on this input, operations to detect objects in the corpus of images and generate keywords for those objects are performed.

For example, if a corpus of images includes a set of pictures of hotel rooms that will be used in various promotional materials (e.g., in print, on the internet, displayed using different devices, etc.) and a content brief specifies to automatically crop images that focus on “comfortable hotel rooms for a business traveler,” operations to detect objects in the corpus of images can include operations to detect salient objects in the images and to rank those objects. In some aspects, objects are ranked based on their saliency, wherein such saliency includes, but is not limited to legibility, proximity to focal-points, location within human gaze, etc. In this example, for an image of a hotel room with two beds, a nightstand, some pillows, a curtained window, and an air-conditioning unit, operations to detect objects could produce a ranked list comprising {bed, nightstand, pillow, air conditioner, curtain} while another image, possibly of the same room but from a different angle that includes a chair and a television could produce a ranked list comprising {bed, nightstand, television, pillows, chair, curtains}. In some configurations, the system may determine “weights” of detected objects in line with prominence of salience factors, causing more than one detected objects to have same ranking in a ranked list.

In accordance with some aspects of the technology described herein, after object detection is performed, operations to infer objects in the corpus of images are performed. Continuing the example above, if the content brief is to focus on “comfortable hotel rooms for a business traveler,” operations to infer objects in the image corpus might use a generative artificial intelligence (AI) system to “produce a list of objects (ranked by relevance) that should be highlighted in images of comfortable hotel rooms for a business traveler, if present.” Such operations to infer objects may produce a list that includes “an ergonomic work desk,” “high-speed internet access,” “comfortable bedding,” “an in-room coffee maker,” “a fitness center,” “lounge access,” and so on. It should be noted that this list of inferred objects is a list of objects that should be highlighted if present in the images of the image corpus and not necessarily a list of objects that are present in the images. For example, “a fitness center” may not be visible in the image of a hotel room with two beds, a nightstand, some pillows, a curtained window, and an air-conditioning unit and “comfortable bedding” may not be visible in an image of the front lobby. Similarly, it is possible that none of the images in the image corpus show “high-speed internet access.”

In accordance with some aspects of the technology described herein, after object inference, operations to detect object regions and re-rank objects in the corpus of images are performed. Continuing the example above, a first list of the identified objects in the images and a second list of the inferred objects from the content brief are combined and re-ranked so that, for example, “pillow” and “bed” from the identified list are combined with “comfortable bedding” from the inferred list and a combined ranking is generated (e.g., the combined list may have an entry for “comfortable bedding (including pillow and bed).”

In accordance with some aspects of the technology described herein, after object region detection and re-ranking, operations to augment objects in the corpus of images are performed. Continuing the example above, a combined list might include items like “kids-play area,” “expansive dining area,” “a room safe,” and so on, that may not be relevant to a content brief of “comfortable hotel rooms for a business travel.” In this example, operations to augment the list might remove the above elements from the combined list and re-rank the remaining items in the list so that a final list includes “ergonomic work desk,” “smart TV (includes television, TV),” “comfortable bedding (includes pillow, bed),” and so on. The operations to augment the list might also de-emphasize any completely irrelevant objects (e.g., the owner's “dog”) so that no images will include the dog.

In accordance with some aspects of the technology described herein, after object augmentation, operations to crop images of the image corpus are performed. Continuing the example above, automatic image cropping can then be performed that satisfies the size and/or aspect ratio (e.g., of the desired crop) while preserving as many of the items of the final list while focusing on the higher ranked or more important items. For example, a desired crop of an image that shows both “soundproofing” and “comfortable bedding” would try to crop so that both elements are shown, but would prefer “soundproofing” over “comfortable bedding” in the event that both elements could not be preserved in the crop.

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

### BRIEF DESCRIPTION OF THE DRAWINGS

The present technology is described in detail below with reference to the attached drawing figures, wherein:

FIG. 1 is a block diagram illustrating an exemplary system to automatically crop images, in accordance with implementations of the present disclosure;

FIG. 2 is a block diagram showing an example data flow of a system to automatically crop images, in accordance with some implementations of the present disclosure;

FIG. 3 is a block diagram showing details of object detection used to automatically crop images, in accordance with some implementations of the present disclosure;

FIG. 4 is a block diagram showing details of object inference used to automatically crop images, in accordance with some implementations of the present disclosure;

FIG. 5 is a block diagram showing details of object augmentation used to automatically crop images, in accordance with some implementations of the present disclosure;

FIG. 6 is a block diagram showing details of object region detection and re-ranking used to automatically crop images, in accordance with some implementations of the present disclosure;

FIG. 7 is a block diagram showing details of automatic image cropping using object detection, object inference, object augmentation, and object region detection, in accordance with some implementations of the present disclosure;

FIG. 8 is a flow diagram illustrating a method for automatically cropping images, in accordance with some implementations of the present disclosure; and

FIG. 9 is a block diagram of an exemplary computing environment suitable for use in implementations of the present disclosure.

### DETAILED DESCRIPTION

### Definitions

Various terms are used throughout this description. Definitions of some terms are included below to provide a clearer understanding of the ideas disclosed herein.

As used herein, an “image” is a single digital image or a digital video (e.g., a plurality of images) that is to be automatically cropped using systems and methods described herein. In some aspects, an image comprises pixel values based on a raster image file or a vector image file. In some instances, an image is referred to as a “source image,” or as an “input image,” or as a “digital asset.”

As used herein, an “image corpus” is a collection of images that are related to each other (e.g., pictures and videos of a new hotel) and are, collectively, to be automatically cropped using systems and methods described herein.

As used herein, a “content brief” is a specification comprising natural language text for how automatic image cropping is to be performed using systems and methods described herein. In some instances, a content brief specifies a type of content to be preserved. In some instances, a content brief specifies sizes and/or aspects rations of cropped images. In some instances, a content brief describes the desirable business objective the image corpus helps achieve. In some instances, a content brief is referred to as a “campaign brief.”

As used herein, a “salient feature” is a feature of an image (e.g., an object present in the image) that is desired (e.g., is to be preserved), or is neutral (e.g., is neither to be preserved nor restricted), or is not desired (e.g., is to be restricted) when operations described herein to perform automatic image cropping are performed. In some instances, a salient feature has an associated “salience,” which is a ranking of objects of that type based on certain attributes, including but not limited to, legibility, proximity to focal-point, and human gaze. In some instances, objects that are to be preserved have a positive salience, objects that are neither to be preserved nor restricted have a zero salience, and objects that are to be restricted have a negative salience.

As used herein, a “crop” is an operation to crop a source image to a different size or aspect ratio, which generates a “cropped image.” As used herein, a “cropped image” is a source image that has been cropped to a specified size or aspect ratio. For example, if a source image is 500×500 pixels, a crop is an operation to select a subset of the pixels of that image based on a size (e.g., 250×250 pixels) or an aspect ratio (e.g., five-by-three). In some instances, for a crop of, for example, 250×250 pixels, there are many 250×250 pixel subsets of that can be selected to generate a cropped image of 250×250 pixels.

As used herein, an “aspect ratio” is a ratio of the width of an image to the height of the image. For example, an aspect ratio of “five-by-three” is an indication that an image is five units wide by three units high where a unit is selected as a partitioning of the size of the image. For example, if the image is five-hundred pixels wide by three-hundred pixels high, the unit will be one-hundred pixels. Some examples of aspect ratios include “one-by-one,” “sixteen-by-nine,” etc. In some instances, an aspect ratio is expressed as a ratio (e.g., “5:3” or “16:9”) or as a pair of numbers with an “x” (e.g., 16×9). In some instances, for a three-dimensional image (e.g., with height, width, and depth), an aspect ratio can be expressed as three numbers. As may be contemplated, images may be of different sizes but have the same aspect ratio (e.g., a 500×300image and a 250×150 image have the same aspect ratio of 5:3, with unit as one-hundred pixels and fifty pixels, respectively).

As used herein, an “image region” is a portion of an image that includes a particular salient feature. For example, if an image contains a bed and the salient feature is “bed,” the image region comprises the pixels that show the bed in the image. In some aspects, an image region is a regularly shaped portion of the image (e.g., a rectangle) that at least includes all of the pixels of the image that show the bed. In some aspects, an image region includes only the pixels of the image that show the bed. In some aspects, an image region includes majority of the pixels of the image that show the bed, with other pixels describing unrelated objects.

As used herein, a “rank” or a “ranking” is a value associated with a keyword that indicates the relative importance of objects of that keyword (e.g., beds). In some aspects, a “rank” or “ranking” of a keyword is equivalent to the salience of objects of that keyword.

As used herein, an “object” is an element of an image that is detectable by, for example, an object detection module (described herein). For example, an image of a hotel room can include objects such as “bed,” “bedding,” “coffee maker,” “desk,” “television,” etc. As used herein, an object is an indicator of pixels in an image that are used to display the object so that, for example, if a television is shown at pixels (x₁, y₁) to (x₂, y₂) of an image, those pixels are “television” pixels (e.g., they correspond to the “television”object).

As used herein, an “object keyword” is a keyword that is used to label an object. In some instances, an object (e.g., a television) can have multiple object keywords (e.g., “Television,” “TV,” “Smart TV,” “Electronics,” “Amenities,” etc. In some instances, pixels that are used to display an object (e.g., as described above) can have multiple disjoint object keywords when, for example, one object obscures another so that, for example, a set of pixels of an image from (x₁, y₁) to (x₂, y₂) might be labeled as both “Bed” and “Desk” if a portion of the desk obscures a portion of the bed or vice-versa.

As used herein, “confidence” is a value associated with the importance of object keywords in reference to an image. In some aspects, confidence is based on the number of instances that a particular object occurs in an image. In some aspects, confidence is based on the accuracy with which the particular object can be considered represented in an image. In some aspects, confidence is based on the number of instances that a particular object occurs in an image corpus.

### Overview

Adjusting digital assets such as images and videos to accommodate a variety of viewport shapes and sizes is challenging for many reasons. Simply cropping a source image from its original size to a desired size can remove important details from the image when, for example, those details are at the edges of the image. Doing such cropping manually can be very time and resource intensive, requiring opening the image, locating important details in the image, and adjusting the cropping to both preserve those details and conform to the desired size. This time and resource requirement can be compounded when there are many source images and several desired crop sizes and aspect ratios (e.g., one for print, one for a website, one for a mobile device, etc.). In a typical advertising campaign, for example, there can be thousands of images and several desired sizes or aspect ratios for each, requiring many hundreds of hours to complete the images for the advertising campaign.

However, typical automatic cropping techniques (e.g., where an algorithm is used to crop images to the desired size or shape) are prone to errors. A naïve approach of cropping without consideration of the content produces generally poor results and more focused approaches that consider the content of the images frequently fail when they are unable to balance the desired size or shape with preserving the content. For example, an auto-crop operation that identifies objects in an image or video and crops around that identified object usually does not allow the user to specify details to focus on and/or details to avoid. In an image where, for example, one object is at the left side of the image and another object is at the right size of the image, an auto-crop operation would have no guidelines on which to keep (left, right, or both) and which to discard.

Aspects of the technology described herein automatically crop images of an image corpus based on information in a content brief. In accordance with some aspects, a set of images (the image corpus) is to be automatically cropped so that elements in the images that are more relevant to the content brief are preserved. Using the example from above, an image corpus might include a thousand images of hotel rooms from a new business hotel and a content brief might specify cropping each of the images to five different sizes or aspect ratios that highlight elements of “comfortable hotel rooms for a business traveler.”

According to some aspects, a list of objects that are present in the images is generated (e.g., using object detection) and ranked according to importance. This list is a list of all objects in all of the images, but does not necessarily include duplicates. For example, if most of images include beds, then “beds” would appear once in the list with a high ranking while if only a few of the images include pictures of the owner's dog, the “dog” might appear in the list, but with a very low ranking. It should be noted that this list may include different terms for similar objects (e.g., “television”, “smart TV”, “TV”), each of which might have a different ranking. It should be noted that, in some aspects, object detection stores the region of the image where the object is detected and in some aspects, region detection is a separate step.

According to some aspects, a list of objects that are important (e.g., should be highlighted or preserved) in the images is generated (e.g., using object inference). This list is a list that is generated using the content brief. This list could be manually generated or could be generated using generative AI, as described herein. For example, a content brief to highlight elements of “comfortable hotel rooms for a business traveler,” could be used to generate a prompt to a generative artificial intelligence (AI) to generate such a list, which would then cause a list of such desired elements to be generated, as described above.

According to some aspects, the list of objects that are detected (e.g., in the image corpus) and the list of objects that are inferred (e.g., using the content brief) are combined and re-ranked so that similar objects (e.g., “smart TV”, “TV”, and “television”) are grouped together as a single object with a combined ranking.

According to some aspects, this combined and re-ranked list of objects can be augmented (e.g., by removing some objects from the list, re-ranking the objects, adding objects to the list, etc.) and this augmented list is then used to perform the automatic cropping so that, if a desired image crop can focus on only one region of an image, higher ranked objects are preserved. In the example with a thousand images and five different sizes or aspect ratios, five-thousand cropped images can be automatically produced (e.g., five cropped images for each of the thousand source images).

Aspects of the technology described herein provide a number of improvements over existing technologies. For example, consider a content brief to generate five cropped images for each of a thousand source images, focusing on “comfortable hotel rooms for a business travel.” Generating such cropped images manually is error prone and time consuming (e.g., at two-minutes per image, generating five thousand images could take hundreds of hours) and it is likely that, over the course of those hours, numerous errors could be made. Automatically cropping those images using the specified content brief and using the technology described herein enables quick and automatic generation of the cropped images, which more efficiently uses computing resources.

Aspects of the technology described herein also provide a number of improvements over existing automatic cropping technologies. For example, existing automatic cropping technologies may identify salient objects in digital assets (e.g., images and/or videos) and automatically crop images around those objects, but such technologies provide no means of preferring some objects over others according to ranking, provide no means of enabling a user to specify objects to focus on or avoid, and provide no means of combining detected objects with inferred objects to generate a ranked and combined list of desired elements to guide the automatic cropping of images.

Similarly, aspects of the technology described herein allow the scope of an image corpus to be changed (e.g., by adding or removing digital assets), the content brief to be changed (e.g., to focus on different elements), or the list of objects to focus on or avoid to be changed. For example, the technology described herein easily allows a user to change from “comfortable hotel rooms for a business traveler” to “luxury hotel rooms for a romantic getaway” to generate a new set of image crops.

### Example Systems and Methods for Automatically Cropping Images

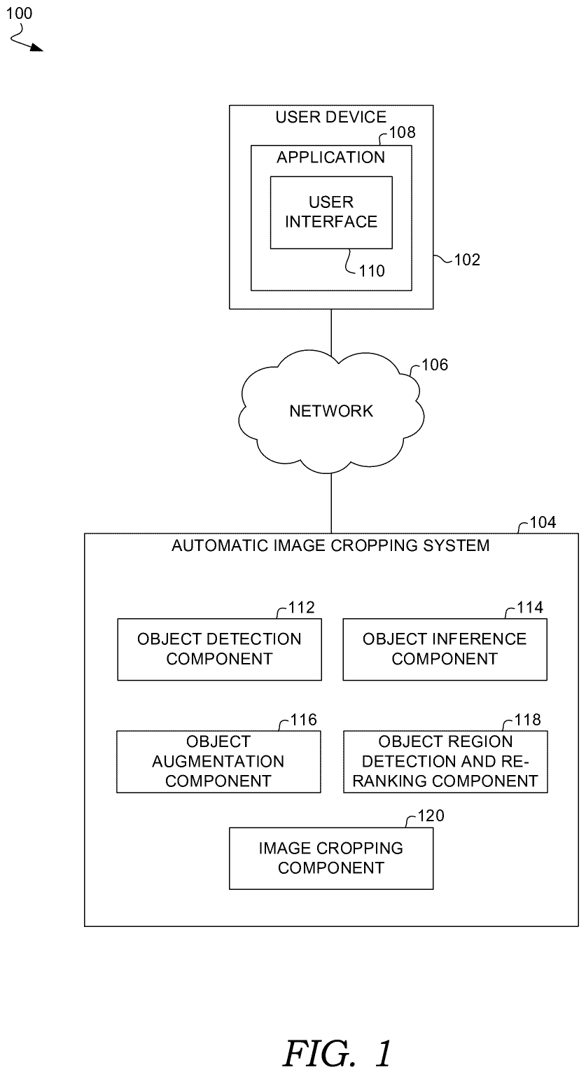

With reference now to the drawings, FIG. 1 is a block diagram illustrating an exemplary system 100 to automatically crop images, in accordance with implementations of the present disclosure. It should be understood that this and other arrangements described herein are set forth only as examples. Other arrangements and elements (e.g., machines, interfaces, functions, orders, and groupings of functions, etc.) can be used in addition to or instead of those shown, and some elements can be omitted altogether. Further, many of the elements described herein are functional entities that can be implemented as discrete or distributed components or in conjunction with other components, and in any suitable combination and location. Various functions described herein as being performed by one or more entities can be carried out by hardware, firmware, and/or software. For instance, various functions can be carried out by a processor executing instructions stored in memory.

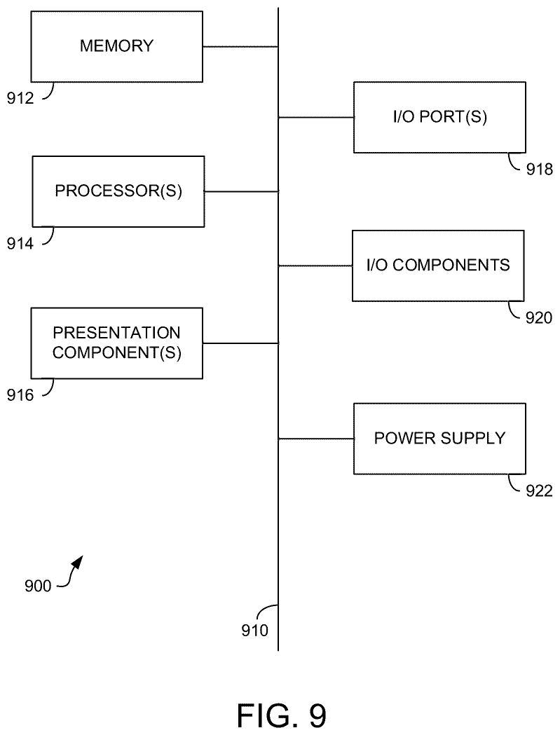

The system illustrated in block diagram 100 is an example of a suitable architecture for implementing certain aspects of the present disclosure. Among other components not shown, the system illustrated in block diagram 100 includes a user device 102 and an automatic image cropping system 104. Each of the user device 102 and the automatic image cropping system 104 shown in FIG. 1 can comprise one or more computer devices, such as the computing device 900 of FIG. 9, described below. As shown in FIG. 1, the user device 102 and the automatic image cropping system 104 can communicate via a network 106, which may include, without limitation, one or more local area networks (LANs) and/or wide area networks (WANs). Such networking environments are commonplace in offices, enterprise-wide computer networks, intranets, and the Internet. It should be understood that any number of user devices and servers may be employed within the system illustrated in block diagram 100 within the scope of the present technology. Each device or server may comprise a single device or multiple devices cooperating in a distributed environment. For instance, the automatic image cropping system 104 could be provided by multiple server devices collectively providing the functionality of the automatic image cropping system 104, as described herein. Additionally, other components not shown may also be included within the network environment.

The user device 102 can be a client device on the client-side of the operating environment illustrated in block diagram 100, while the automatic image cropping system 104 can be on the server-side of the operating environment illustrated in block diagram 100. The automatic image cropping system 104 can comprise server-side software designed to work in conjunction with client-side software on the user device 102 so as to implement any combination of the features and functionalities discussed in the present disclosure. For example, the user device 102 can include an application 108 for interacting with the automatic image cropping system 104. The application 108 can be, for instance, a web browser or a dedicated application for providing functions, such as those described herein. This division of an operating environment illustrated in block diagram 100 is provided to illustrate one example of a suitable environment. There is no requirement for each implementation that any combination of the user device 102 and the automatic image cropping system 104 remain as separate entities. While the operating environment illustrated in block diagram 100 illustrates a configuration in a networked environment with a separate user device and automatic image cropping system, it should be understood that other configurations can be employed in which aspects of the various components are combined. For instance, in some instances, aspects of the automatic image cropping system 104 can be implemented in part or in whole by the user device 102.

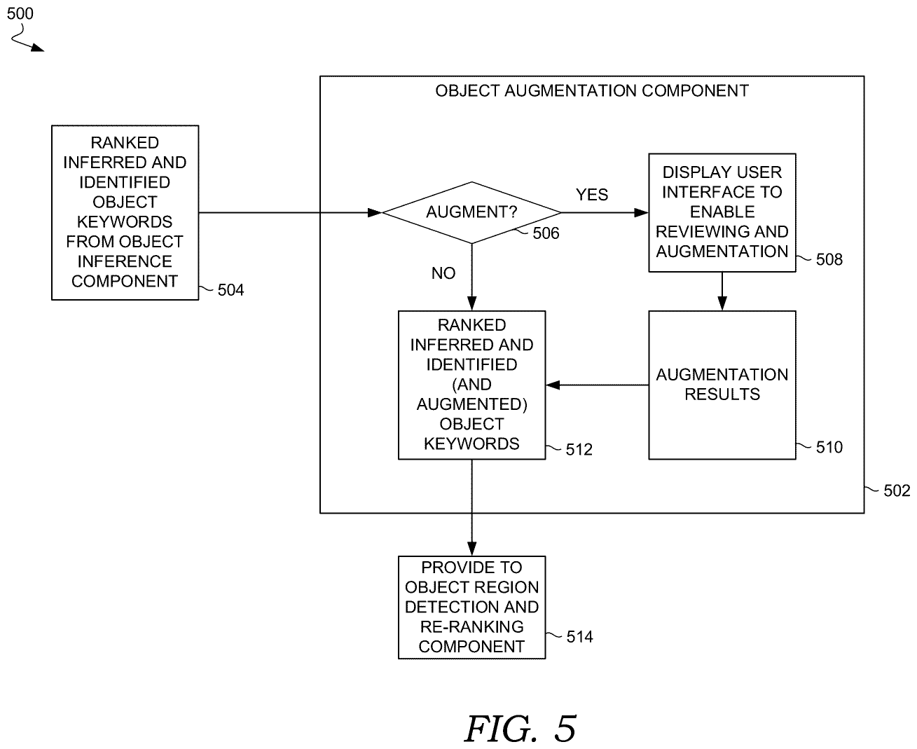

In some configurations, the application 108 can comprise a user interface 110. In some configurations, the user interface 110 provides one or more user interfaces to a user of a device, such as the user device 102 for interacting with the automatic image cropping system 104. In some instances, the user interface 110 can be presented on the user device 102 via the application 108, which can be a web browser or a dedicated application for interacting with the automatic image cropping system 104. For instance, the user interface 110 can provide user interfaces for, among other things, receiving input from a user and providing responses to the user. It should be noted that, while the user interface 110 is shown as an element of application 108, in some embodiments, the automatic image cropping system 104 further includes a user interface component (not shown in FIG. 1) that provides one or more user interfaces for interacting with the automatic image cropping system 104 (e.g., such as user interface 508, described herein at least in connection with FIG. 5). In some aspects, a user interface component provides one or more user interfaces to a user device, such as the user device 102 via the application 108.

The user device 102 may comprise any type of computing device capable of use by a user. For example, in one aspect, a user device may be the type of computing device 900 described in relation to FIG. 9 herein. By way of example and not limitation, the user device 102 may be embodied as a personal computer (PC), a laptop computer, a mobile or mobile device, a smartphone, a tablet computer, a smart watch, a wearable computer, a personal digital assistant (PDA), an MP3 player, global positioning system (GPS) or device, video player, handheld communications device, gaming device or system, entertainment system, vehicle computer system, embedded system controller, remote control, appliance, consumer electronic device, a workstation, or any combination of these delineated devices, or any other suitable device. A user may be associated with the user device 102 and may interact with the automatic image cropping system 104 via the user device 102.

In some configurations, the automatic image cropping system 104 is implemented using artificial intelligence (“AI”) models that generate responses to user queries through natural language interaction. In such instances, the automatic image cropping system 104 uses artificial intelligence and machine learning algorithms to understand user queries, interpret context, and generate responses by accessing relevant information from various sources. In at least one embodiment, the automatic image cropping system 104 uses generative models such as those described herein to understand user queries, interpret context, and generate automatically cropped images using systems, methods, operations, and techniques such as those described herein.

As shown in FIG. 1, the automatic image cropping system 104 comprises an object detection component 112, an object inference component 114, an object augmentation component 116, an object region detection and re-ranking component 118, and/or an image cropping component 120. The modules/components of the automatic image cropping system 104 may be in addition to other components that provide further additional functions beyond the features described herein. The automatic image cropping system 104 can be implemented using one or more server devices, one or more platforms with corresponding application programming interfaces, cloud infrastructure, and the like. While the automatic image cropping system 104 is shown as separate from the user device 102 in the configuration of FIG. 1, it should be understood that in other configurations, some or all of the functions of the automatic image cropping system 104 can be provided on the user device 102. Additionally, in some configurations, one or more of the components of the automatic image cropping system 104 shown in FIG. 1 can be provided by the user device 102 and/or another device in another location not shown in FIG. 1. In some configurations, the components of the automatic image cropping system can be provided by a single entity or by multiple entities.

In some aspects, the functions performed by components of the automatic image cropping system 104 are associated with one or more applications, services, or routines. In particular, such applications, services, or routines may operate on one or more user devices and servers, may be distributed across one or more user devices and servers, or may be implemented in the cloud. Moreover, in some aspects, these components of the automatic image cropping system 104 may be distributed across a network, including one or more servers and client devices, in the cloud, and/or may reside on a user device. Moreover, these components, functions performed by these components, or services carried out by these components may be implemented at appropriate abstraction layer(s) such as the operating system layer, application layer, hardware layer, etc., of the computing system(s). Alternatively, or in addition, the functionality of these components and/or the aspects of the technology described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc. Additionally, although functionality is described herein with regards to specific components shown in the example system illustrated in block diagram 100, it is contemplated that in some aspects, functionality of these components can be shared or distributed across other components.

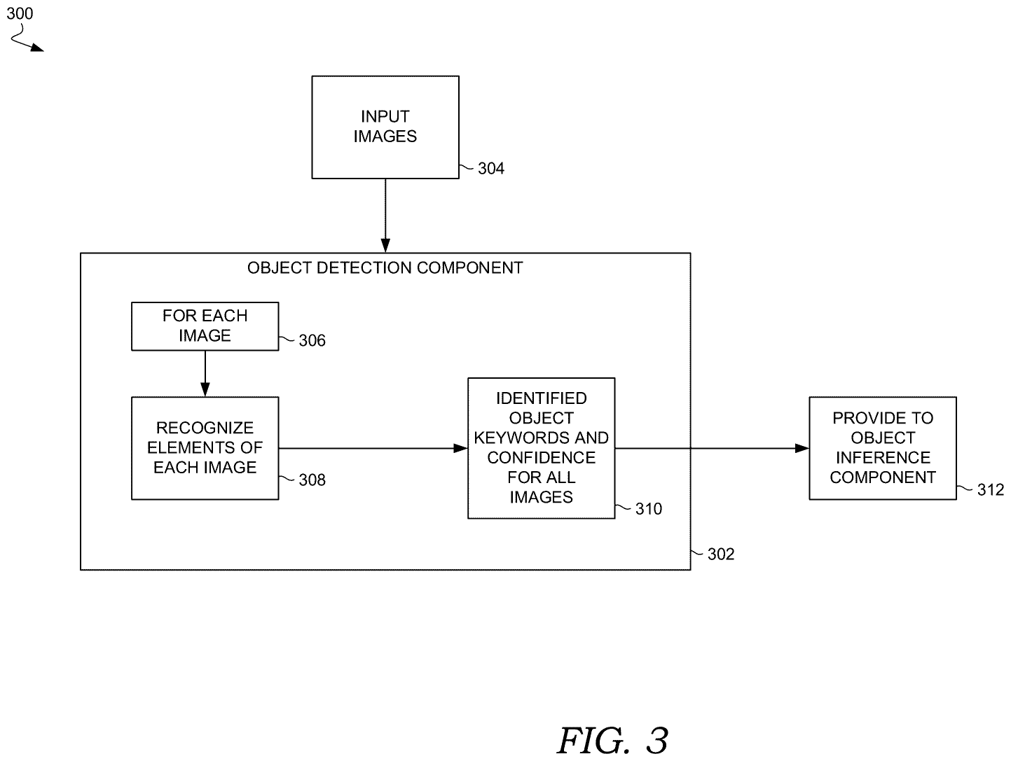

Given an input from a user device (e.g., user device 102) to automatically crop a set of images (e.g., an image corpus), the automatic image cropping system 104 uses the object detection component 112 to detect objects in the corpus of images and generate keywords for those objects. In come configurations, the object detection component 112 receives, as input, a set of images (e.g., an image corpus, described below) that are to be automatically cropped. In at least one embodiment, the object detection component 112 uses a generative model (e.g., an LLM) to detect objects in the corpus of images and generate keywords for those objects, using systems, methods, operations, and techniques described herein at least in connection with FIG. 3. In some aspects, the object detection component 112 a recognize anything model (RAM) to detect objects in the corpus of images and generate keywords for those objects. As used herein, a recognize anything model (RAM) is a strong image tagging model that uses artificial intelligence/machine learning (AI/ML) to detect a wide variety of objects in images (or videos) and provide tags to those objects. Further details of the object detection component 112 are described below, in connection with FIG. 3.

In some aspects, the object detection component 112 generates a prompt based on a natural language query received from the user device 102 (or at least a portion thereof) and provides the prompt to the generative model to detect objects in the corpus of images and generate keywords for those objects. In some configurations, the prompt can include text instructing the generative model regarding how to generate the text for the output (e.g., do not include explanations, do not use certain words, perform conversions, etc.). In some instances, the prompt is generated to include additional information to help guide the generative model in generating the image description. In some aspects, one or more query expansion operations can be performed for the natural language query. By way of example only and not limitation, synonym expansion could be performed to add synonyms for words/phrases in the query, and/or acronym expansion could be performed to add words/phrases for acronyms in the query. The query expansion operations can be performed by the generative model or separately.

In some aspects, the generative model used by the object detection component 112 to detect objects in the corpus of images and generate keywords for those objects comprises a multi-modal language model that includes a set of statistical or probabilistic functions to perform Natural Language Processing (NLP) in order to understand, learn, and/or generate human natural language content based on source images. For example, a language model can be a tool that determines the probability of a given sequence of words occurring in a sentence or natural language sequence. Simply put, a language model can be a model that is trained to predict the next word in a sentence. A language model is called a large language model (LLM) when it is trained on an enormous amount of data and/or has a large number of parameters. Some examples of LLMs include those described above. These models have capabilities ranging from writing a simple essay to generating complex computer codes - all with limited to no supervision. In some configurations, a language model can be multi-modal and can receive image input (e.g., a source image) and provide a description of the image. Accordingly, an LLM can comprise a deep neural network that is very large (billions to hundreds of billions of parameters) and understands, processes, and produces human natural language by being trained on massive amounts of text. These models can predict future words in a sentence letting them generate sentences similar to how humans talk and write or otherwise communicate in a form dictated, for instance, by a prompt. In some aspects, the generative model used by the object detection component 112 to detect objects in the corpus of images and generate keywords for those objects can be an off-the-shelf model or can be a custom model. In some aspects, the generative model used by the object detection component 112 to detect objects in the corpus of images and generate keywords for those objects comprises one or more of the models described herein and/or other such models.

In accordance with some aspects, the generative model used by the object detection component 112 to detect objects in the corpus of images and generate keywords for those objects comprises a neural network. As used herein, a neural network comprises multiple operational layers, including an input layer and an output layer, as well as any number of hidden layers between the input layer and the output layer. Each layer comprises one or more mathematical functions referred to as “neurons”. Different types of layers and networks connect neurons in different ways. Neurons have weights, an activation function that defines the output of the neuron given an input (including the weights), and an output. The weights are the adjustable parameters that cause a network to produce a desired output.

In some configurations, the generative model used by the object detection component 112 to detect objects in the corpus of images and generate keywords for those objects is a pre-trained model (e.g., GPT-4) that has not been fine-tuned. In other configurations, the generative model is a model that is built and trained from scratch or a pre-trained model that has been fine-tuned. In such configurations, the generative model can be trained or fine-tuned using training data. During training, weights associated with each neuron can be updated. Originally, the generative model can comprise random weight values or pre-trained weight values that are adjusted during training. In one aspect, the generative model is trained using backpropagation. The backpropagation process comprises a forward pass, a loss function, a backward pass, and a weight update. This process is repeated using the training data. The goal is to update the weights of each neuron (or other model component) to cause the generative model to produce useful image descriptions given source images. Once trained, the weight associated with a given neuron can remain fixed. The other data passing between neurons can change in response to a given input. Retraining the network with additional training data can update one or more weights in one or more neurons.

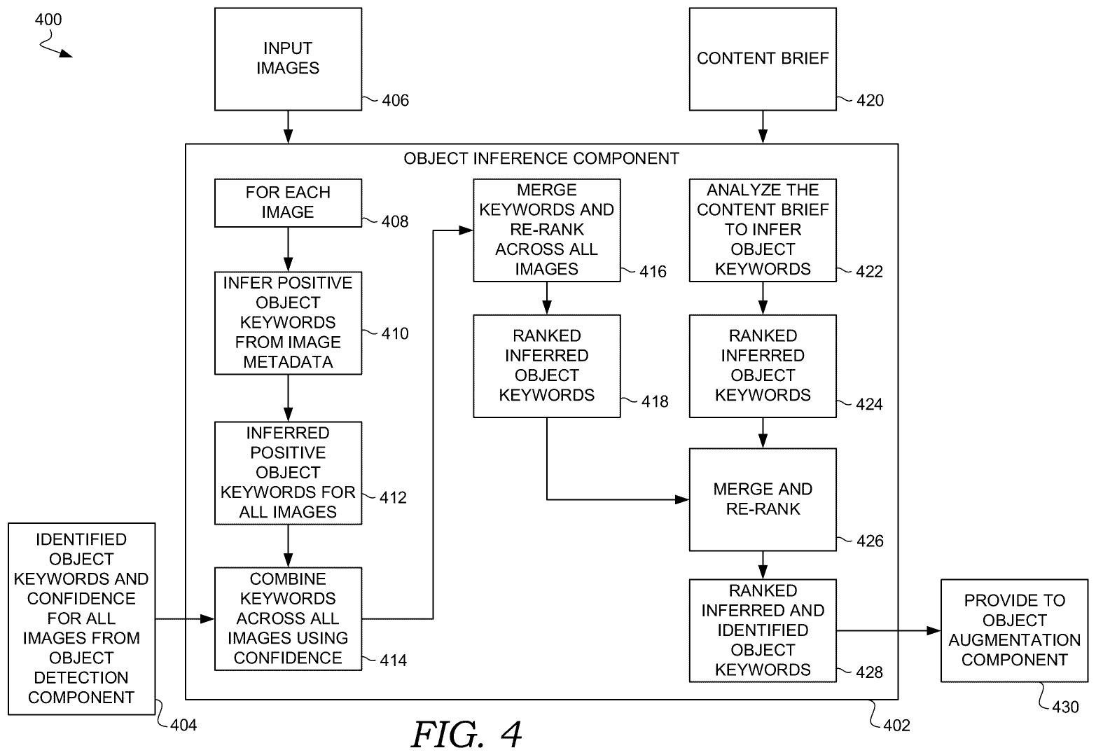

In some configurations, the automatic image cropping system 104 uses the object inference component 114 to infer object keywords from image metadata and rank those object keywords. In some configurations, the object inference component 114 receives, as input, a set of keywords from the object detection component 112. In come configurations, the object inference component 114 uses the keywords generated by the object detection component 112. In at least one embodiment, the object inference component 114 uses a generative model (e.g., an LLM) to infer object keywords from image metadata and rank those object keywords, using systems, methods, operations, and techniques described herein at least in connection with FIG. 4. In some aspects, the object inference component 114 uses a large-language model (LLM) to infer object keywords from image metadata and rank those object keywords. Further details of the object inference component 114 are described below, in connection with FIG. 4.

In some aspects, the generative model used by the object inference component 114 to infer object keywords from image metadata and rank those object keywords, can comprise a language model, can comprise a neural network, can be a pre-trained model (e.g., GPT-4) that has not been fine-tuned, or can be a fine-tuned model, all as described above in connection with the object detection component 112. In some aspects, the generative model used by the object inference component 114 to infer object keywords from image metadata and rank those object keywords can be an off-the-shelf model or can be a custom model, as described above. In some aspects, the generative model used by the object inference component 114 to infer object keywords from image metadata and rank those object keywords can comprise one or more of these and/or other such models. In some configurations, the rank may include aspects of weighting of values, and as such, one or more object keywords may have the same rank.

In some configurations, the automatic image cropping system 104 uses the object augmentation component 116 to augment the ranked object keywords. In some configurations, the object augmentation component 116 receives, as input, ranked keywords from the object inference component 114. In come configurations, the object augmentation component 116 uses the ranked keywords generated by the object inference component 114 to augment the ranked object keywords, using systems, methods, operations, and techniques described herein at least in connection with FIG. 5.

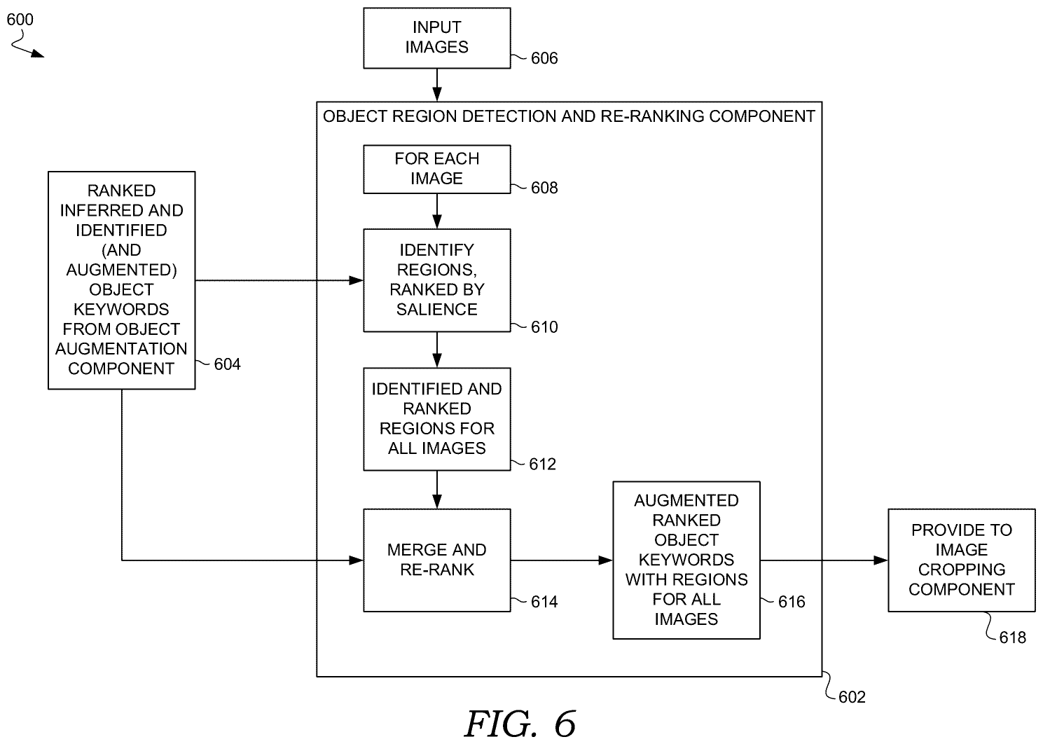

In some configurations, the automatic image cropping system 104 uses the object region detection and re-ranking component 118 to identify regions within the objects corresponding to the ranked object keywords and to re-rank those keywords using the identified regions. In some configurations, the object region detection and re-ranking component 118 receives, as input, augmented keywords generated by the object augmentation component 116. In at least one embodiment, the object region detection and re-ranking component 118 uses a generative model (e.g., an LLM) to identify regions within the objects corresponding to the ranked object keywords and to re-rank those keywords using the identified regions, using systems, methods, operations, and techniques described herein at least in connection with FIG. 6. In some aspects, the object region detection and re-ranking component 118 uses an LLM to identify regions within the objects corresponding to the ranked object keywords and to re-rank those keywords using the identified regions. Further details of the object region detection and re-ranking component 118 are described below, in connection with FIG. 6.

In some aspects, the generative model used by the object region detection and re-ranking component 118 to identify regions within the objects corresponding to the ranked object keywords and to re-rank those keywords using the identified regions, can comprise a language model, can comprise a neural network, can be a pre-trained model (e.g., GPT-4) that has not been fine-tuned, or can be a fine-tuned model, all as described above in connection with the object detection component 112. In some aspects, the generative model used by the object region detection and re-ranking component 118 to identify regions within the objects corresponding to the ranked object keywords and to re-rank those keywords using the identified regions, can be an off-the-shelf model or can be a custom model, as described above. In some aspects, the generative model used by the object region detection and re-ranking component 118 to identify regions within the objects corresponding to the ranked object keywords and to re-rank those keywords using the identified regions, can comprise one or more of these and/or other such models.

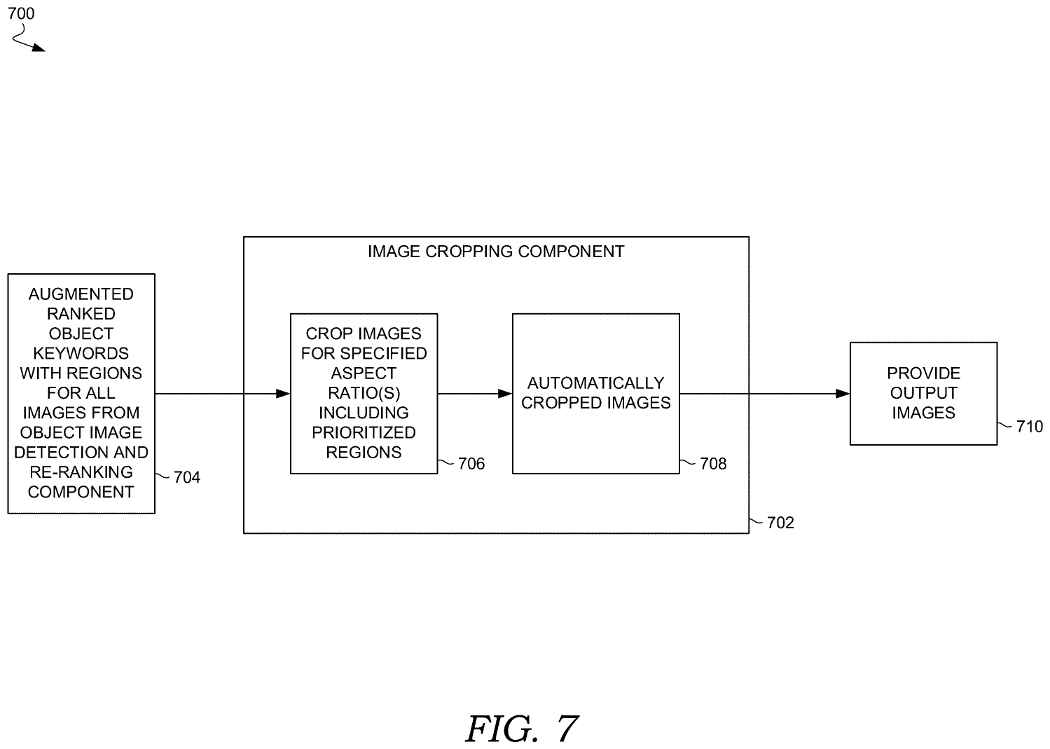

In some configurations, the automatic image cropping system 104 uses the image cropping component 120 to automatically crop the images of the image corpus. In some configurations, the image cropping component 120 receives, as input, keywords and regions generated by the object augmentation component 118, using systems, methods, operations, and techniques described herein at least in connection with FIG. 7.

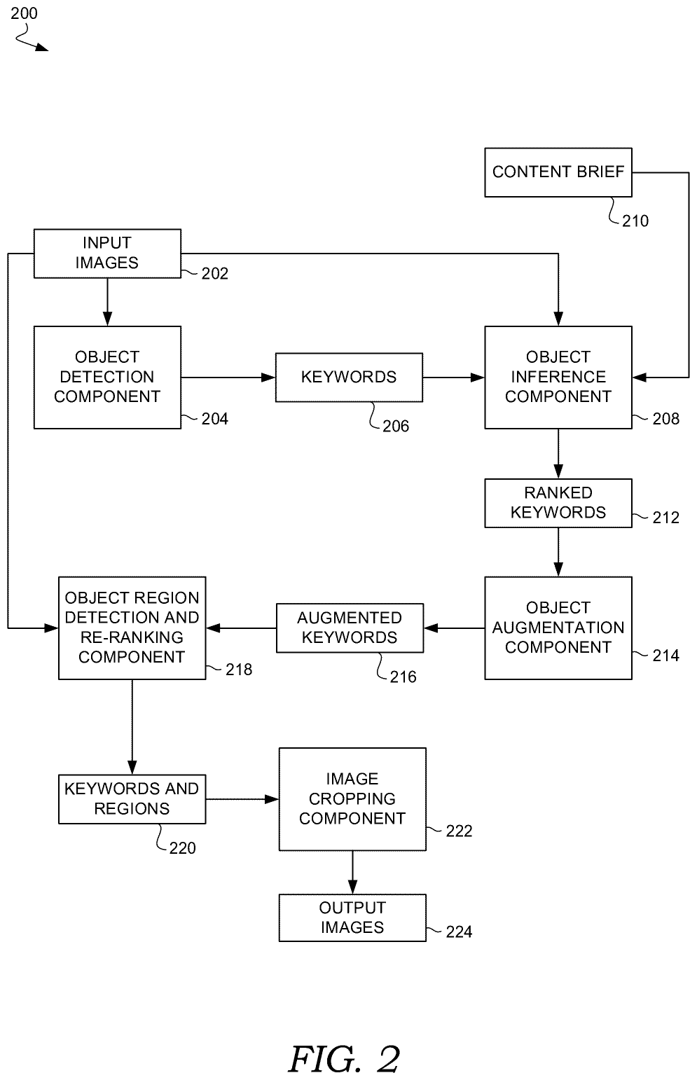

FIG. 2 is a block diagram 200 showing an example data flow of a system to automatically crop images, in accordance with some implementations of the present disclosure. In some implementations, an object detection component 204 receives a set of input images 202. In some aspects, the object detection component is an object detection component such as object detection component 112, described herein at least in connection with FIG. 1. In some aspects, input images 202 is a corpus of images comprising a plurality of images. In some aspects, input images 202 includes a video comprising a plurality of video frames, wherein each frame of the video includes an image. In some aspects, input images 202 comprises a plurality of videos, each of which comprises a plurality of video frames. In some aspects, input images 202 comprises one or more images and one or more videos. In some aspects, input images 202 comprises photographs and/or videos of physical objects. In some aspects, input images 202 comprises simulated (e.g., rendered) images or frames generated by a computer device such as those described herein. In some aspects, input images 202 comprises a combination of photographs and/or videos of physical objects and simulated (e.g., rendered) images or frames generated by a computer device. In some aspects, the object detection component 204 uses the set of input images 202 to generate keywords 206, using systems and methods described herein at least in connection with FIG. 3.

In some implementations, an object inference component 208 receives the set of input images 202, the keywords 206 from the object detection component 204, and/or a content brief 210. In some aspects, the object inference component 208 is an object inference component such as the object inference component 114, described herein at least in connection with FIG. 1. In some aspects, the content brief 210 is comprises a description of desired content (e.g., “comfortable hotel rooms for a business traveler”) and a specification of desired aspect ratios or sizes for image cropping. In some aspects, the object inference component 208 uses the set of input images 202, the keywords 206, and/or the content brief 210 to generate ranked keywords 212, using systems and methods described herein at least in connection with FIG. 4.

In some implementations, an object augmentation component 214 receives the ranked keywords 212 from the object inference component 208. In some aspects, the object augmentation component is an object augmentation component such as object augmentation component 116, described herein at least in connection with FIG. 1. In some aspects, the object augmentation component 214 uses the ranked keywords 212 to generate augmented keywords 216, using systems and methods described herein at least in connection with FIG. 5. In some aspects, the object augmentation component 214 does not alter the ranked keywords 212 (e.g., performs no operations) when generating augmented keywords 216 so that augmented keywords 216 is identical to ranked keywords 212. In some aspects, not shown in FIG. 2, the object augmentation component 214 uses input provided by a user and/or a user interface (e.g., a user interface such as user interface 110, described herein at least in connection with FIG. 1) to generate augmented keywords 216.

In some implementations, an object region detection and re-ranking component 218 receives the input images 202 and/or the augmented keywords 216 (e.g., from the object augmentation component 214). In some aspects, the object region detection and re-ranking component 218 is an object region detection and re-ranking component such as object region detection and re-ranking component 118, described herein at least in connection with FIG. 1. In some aspects, the object region detection and re-ranking component 218 uses the input images 202 and/or the augmented keywords 216 to generate keywords and regions 220, using systems and methods described herein at least in connection with FIG. 6.

In some implementations, an image cropping component 222 receives the keywords and regions 220. In some aspects, the image cropping component 222 is an image cropping component such as image cropping component 120, described herein at least in connection with FIG. 1. In some aspects, the image cropping component 222 uses the keywords and regions 220 to generate output images 224, using systems and methods described herein at least in connection with FIG. 7. In some aspects, output images 224 comprises one or more cropped images corresponding to each image of input images 202. In some aspects, output images 224 comprises a number of cropped images corresponding to each image of input images 202 based, at least in part, on content brief 210. For example, if input images 202 (e.g., an image corpus) comprises one-thousand images and content brief 210 specifies five different sizes and/or aspect ratios for cropping, then output images 224 may comprise five-thousand images (e.g., five cropped images for each image of input images 202).

In some aspects, output images 224 are of the same format as each of input images 202 so that, for example, if input images 202 comprises a plurality of images, output images 224 also comprises a plurality of image. In another example, if input images 202 is a video comprising a plurality of video frames, wherein each frame of the video includes an image, output images 224 may comprise a plurality of videos (e.g., based on content brief 210) wherein each frame of each video of output images 224 includes an image. In another example, if input images 202 comprises a plurality of videos, each of which comprises a plurality of video frames, output images may comprise a larger plurality of videos (e.g., based on content brief 210), each of which comprises a plurality of video frames. In another example, if input images 202 comprises one or more images and one or more videos, output images 224 comprises a plurality of images and a plurality of videos, each of which comprises a plurality of video frames. In examples where input images 202 comprises photographs and/or videos of real-world objects, output images 224 may also comprise photographs and/or videos of real-world objects (e.g., one or more photograph or video corresponding to each photograph or video of input images 202). In examples where input images 202 comprises simulated or rendered images and/or videos, output images 224 may also comprise simulated or rendered images and/or videos (e.g., one or more simulated or rendered images and/or videos corresponding to each simulated or rendered image or video of input images 202).

FIG. 3 is a block diagram 300 showing details of object detection used to automatically crop images, in accordance with some implementations of the present disclosure. In some configurations, an object detection component 302 receives one or more input images 304 and uses input images 304 to identify object keywords. According to some aspects, the object detection component 302 is an object detection component such as the object detection component 204, described in connection with FIG. 2. According to some aspects, the input images 304 are input images such as input images 202, described in connection with FIG. 2.

When the object detection component 302 receives the input images 304, the object detection component 302 processes the input images 304. In some aspects, the object detection component 302, for each image 306, performs operations to recognize elements of each image 308. In some aspects, the object detection component 302 uses a recognize anything model (RAM) to recognize elements of each image 308, as described herein.

In some aspects, not shown in FIG. 3, the object detection component 302 does not process all input images 304 (e.g., performs operations to recognize elements of a subset of input images 304). In some aspects, a pre-processing step (also not shown in FIG. 3) is used to select a subset of input images 304 for processing by object detection component 302. For example, a pre-processing step may select only images that satisfy one or more input criteria (based on, for example, image data or image metadata) from input images 304 for processing by object detection component 302.

In some aspects, when the object detection component 302 performs operations to recognize elements of each image 308 using the RAM, the object detection component 302 generates a set of identified object keywords and confidence for all images 310. In some aspects, the identified object keywords and confidence for all images 310 (e.g., for all processed images of input images 304) comprises a set of object keywords, a corresponding set of confidence values for each of the object keywords, and/or a ranking of each of the object keywords. According to some aspects, the identified object keywords and confidence for all images 310 are keywords such as keywords 206, described in connection with FIG. 2. In some aspects, the identified object keywords and confidence for all images 310 are provided to an object inference component 312 (e.g., provided to an object inference component such as the object inference component described in FIG. 4, below. In some aspects, the identified keywords and confidence for all images 310 are provided to an object inference component 312 using a network, a shared data location, or some other such method including, but not limited to, those described herein.

FIG. 4 is a block diagram 400 showing details of object inference used to automatically crop images, in accordance with some implementations of the present disclosure. In some configurations, an object inference component 402 receives one or more input images 406 and uses input images 406 to infer and rank object keywords using identified object keywords and confidence for all images from object detection component 404 (e.g., identified object keywords and confidence for all images 310, provided by object detection component 302, described herein at least in connection with FIG. 3) and a content brief 420. According to some aspects, the object inference component 402 is an object inference component such as object inference component 208, described in connection with FIG. 2. According to some aspects, the input images 406 are input images such as input images 202, described in connection with FIG. 2. According to some aspects, the content brief 420 is a content brief such as content brief 210, described in connection with FIG. 2.

When the object inference component 402 receives the input images 406, the object inference component 402 processes the input images 406. In some aspects, the object inference component 402, for each image 408, performs operations to infer positive object keywords from image metadata 410. In some aspects, the operations to infer positive object keywords are performed using an LLM, such as those described herein.

In some aspects, not shown in FIG. 4, the object inference component 402 does not process all input images 406 (e.g., performs operations to infer positive object keywords from image metadata 410 using a subset of the input images 406). In some aspects, a pre-processing step (also not shown in FIG. 4) is used to select a subset of the input images 406 for processing by the object inference component 402. For example, a pre-processing step may select only images that satisfy one or more input criteria (based on, for example, image data or image metadata) from the input images 406 for processing by the object inference component 402.

In some aspects, when the object inference component 402 performs operations to infer positive object keywords from image metadata 410 using the LLM, the object inference component 402 generates a set of inferred positive object keywords for all images 412. In some aspects, the inferred positive object keywords for all images 412 (e.g., for all processed images of input images 406) comprise object keywords inferred from object metadata (e.g., a list of possible keywords that may be different from the list of detected object keywords, described above).

In some aspects, the object inference component 402 performs operations to combine keywords across all images using confidence 414. In some aspects, the operations to combine keywords across all images using confidence 414 comprises operations to combine inferred positive object keywords for all images 412 with identified object keywords and confidence for all images from object detection component 404. In some aspects, the operations to combine keywords across all images using confidence 414 are keywords that are ranked according to relevance or salience.

In some aspects, the object inference component 402 uses the results of the operations to combine keywords across all images using confidence 414 and performs operations to merge keywords and re-rank across all images 416 (e.g., for all processed images of input images 406), generating a set of ranked inferred object keywords 418. In some aspects, the ranked inferred object keywords 418 include the merged sets of identified and inferred object keywords that are ranked based, at least in part, on confidence. In some aspects, the ranked inferred object keywords 418 comprise a ranked set of identified and inferred object keywords.

In some aspects, the object inference component 402 performs operations to analyze the content brief to infer object keywords 422 (e.g., to analyze the content brief 420). In some aspects, the operations to analyze the content brief 420 to infer object keywords 422 comprise operations to derive relevant object-identifying keywords using an LLM. In some aspects, the operations to analyze the content brief to infer object keywords 422, generating a set of ranked inferred object keywords 424. In some aspects, the ranked inferred object keywords comprise the inferred object keywords obtained by analyzing the content brief 420 and ranking those inferred object keywords as part of that analysis. In some aspects, the ranked inferred object keywords 424 comprise ranked keywords (e.g., based on the content brief 420) where a higher rank is better. In some aspects, an object that is neutral (e.g., is neither desired nor restricted) may have a rank of zero. In some aspects, an object that is not desired (e.g., is restricted) may have a negative rank.

In some aspects, the object inference component 402 performs operations to merge and re-rank 426 the ranked inferred object keywords 418 and the ranked inferred object keywords 424 (e.g., to combine and re-rank the two sets of ranked inferred object keywords), generating a set of ranked inferred and identified object keywords 428. In some aspects, the operations to merge and re-rank are performed using an LLM. In some aspects, the ranked inferred and identified object keywords 428 can separate positive, neural, and negative rankings so that relative rankings can be derived based on the content brief 420. In some aspects, the ranked inferred and identified object keywords 428 are ranked keywords such as ranked keywords 212, described in connection with FIG. 2. In some aspects, the ranked inferred and identified object keywords 428 are provided to an object augmentation component 430 (e.g., provided to an object augmentation component such as the object augmentation component described in FIG. 5, below. In some aspects, the ranked inferred and identified object keywords 428 are provided to an object augmentation component 430 using a network, a shared data location, or some other such method including, but not limited to, those described herein.

FIG. 5 is a block diagram 500 showing details of object augmentation used to automatically crop images, in accordance with some implementations of the present disclosure. In some configurations, an object augmentation component 502 receives a set of ranked inferred and identified object keywords from object inference component 504. According to some aspects, the object augmentation component 502 is an object augmentation component such as the object augmentation component 214, described in connection with FIG. 2. According to some aspects, the ranked inferred and identified object keywords from object inference component 504 are ranked inferred and identified object keywords 428 generated by an object inference component 402, both described herein at least in connection with FIG. 4 and are ranked keywords such as ranked keywords 212, described herein at least in connection with FIG. 2.

When the object augmentation component 502 receives the ranked inferred and identified object keywords from object inference component 504, the object augmentation component 502 performs operations to determine whether to augment 506 the ranked inferred and identified object keywords from object inference component 504. In some aspects, the determination as to whether to augment 506 the ranked inferred and identified object keywords from the object inference component 504 may be based on a user having opted in to such augmentation, or may be based on a user having opted out of such augmentation (e.g., using a user interface in the object augmentation component, and/or through a prior user interface setting).

In some aspects, the determination whether to augment 506 the ranked inferred and identified object keywords from object inference component 504 is based on a script, a user interface setting, data and/or metadata associated with the image corpus, data and/or metadata in the content brief, or a combination of these and/or other such aspects of the various automatic image cropping operations described herein. For example, a content brief may specify desired content for automatic image cropping and the determination of whether to augment 506 the ranked inferred and identified object keywords from object inference component 504 may be made to ensure that certain objects are ranked higher.

In some aspects, if it is determined to augment 506 the ranked inferred and identified object keywords from object inference component 504 (the “YES” branch), the object augmentation component performs operations to display a user interface to enable reviewing and augmentation 508. In some aspects, the user interface used to enable reviewing and augmentation is a user interface such as user interface 110, described in connection with FIG. 1. In some aspects, after a user interacts with the user interface used to enable reviewing and augmentation, a set of augmentation results 510 (e.g., a list of altered rankings of object keywords) is generated and the augmentation results 510 are used to generate a set of ranked inferred and identified (and augmented) object keywords 512. In some aspects, if the set of augmentation results 510 is not empty (e.g., the set contains some augmentation results), the ranked inferred and identified (and augmented) object keywords 512 is not the same as the ranked inferred and identified object keywords from object inference component 504. For example, if the set of augmentation results 510 is not empty and includes one or more altered rankings, the ranked inferred and identified (and augmented) object keywords 512 will have the ranked inferred and identified object keywords from object inference component 504, but with those rankings changed.

In some aspects, if it is determined to not augment 506 the ranked inferred and identified object keywords from object inference component 504 (the “NO” branch), the ranked inferred and identified (and augmented) object keywords 512 is the same as the ranked inferred and identified object keywords from object inference component 504 (e.g., the ranked inferred and identified object keywords from object inference component 504 will be used as the ranked inferred and identified (and augmented) object keywords 512, with no augmentations).

In some aspects, the ranked inferred and identified (and augmented) object keywords 512 are augmented keywords such as augmented keywords 216, described in connection with FIG. 2. In some aspects, the ranked inferred and identified (and augmented) object keywords 512 are provided to an object region detection and re-ranking component 514 (e.g., provided to an object region detection and re-ranking component such as the region detection and re-ranking component described in FIG. 6, below. In some aspects, the ranked inferred and identified (and augmented) object keywords 512 are provided to an object region detection and re-ranking component 514 using a network, a shared data location, or some other such method including, but not limited to, those described herein.

FIG. 6 is a block diagram 600 showing details of object region detection and re-ranking used to automatically crop images, in accordance with some implementations of the present disclosure. In some configurations, an object region detection and re-ranking component 602 receives one or more input images 606 and uses the input images 606 to generate a set of augmented ranked object keywords with regions for all images 616 using ranked inferred identified (and augmented) object keywords from object augmentation component 604 (e.g., the ranked inferred and identified (and augmented) object keywords 512 provided by the object augmentation component 502, described herein at least in connection with FIG. 5). According to some aspects, the object region detection and re-ranking component 602 is an object region detection and re-ranking component such as the object region detection and re-ranking component 218, described in connection with FIG. 2. According to some aspects, the input images 606 are input images such as input images 202, described in connection with FIG. 2.

When the object region detection and re-ranking component 602 receives the input images 606, the object region detection and re-ranking component 602 processes the input images 606. In some aspects, the object region detection and re-ranking component 602, for each image 608, performs operations to identify regions, ranked by salience 610 using the ranked inferred identified (and augmented) object keywords from object augmentation component 604. In some aspects, the object region detection and re-ranking component 602 uses a grounding DINO model (e.g., a closed-set object detection model with a text encoder that enables open-set object detection) with a segment anything model (SAM), referred to herein as a Grounded-SAM, to processes the input images 606 to identify regions, ranked by salience 610 using the ranked inferred identified (and augmented) object keywords from object augmentation component 604.

In some aspects, not shown in FIG. 6, the object region detection and re-ranking component 602 does not process all input images 606 (e.g., performs operations to identify regions, ranked by salience 610 using a subset of the input images 606). In some aspects, a pre-processing step (also not shown in FIG. 6) is used to select a subset of the input images 606 for processing by the object region detection and re-ranking component 602. For example, a pre-processing step may select only images that satisfy one or more input criteria (based on, for example, image data or image metadata) from the input images 606 for processing by the object region detection and re-ranking component 602.

In some aspects, when the object region detection and re-ranking component 602 performs operations to identify regions, ranked by salience 610 using Grounded-SAM, the object region detection and re-ranking component 602 generates a set of identified and ranked regions for all images 612. In some aspects, the identified and ranked regions for all images 612 (e.g., for all processed images of input images 606) comprise regions where objects are detected in the images, ranked by salience.

In some aspects, the object region detection and re-ranking component 602 performs operations to merge and re-rank 614 using the ranked inferred identified (and augmented) object keywords from object augmentation component 604 to generate a set of augmented ranked object keywords with regions for all images 616. In some aspects, the operations to merge and re-rank 614 comprises operations to merge the identified and ranked regions for all images 612 with the ranked inferred identified (and augmented) object keywords from object augmentation component 604. In some aspects, the operations to merge and re-rank 614 are performed using an LLM.

In some aspects, the augmented ranked object keywords with regions for all images 616 comprise the location of the objects within the images (e.g., the regions) wherein the objects are ranked according to salience. In some aspects, the augmented ranked object keywords with regions for all images 616 are keywords and regions such as keywords and regions 220, described in connection with FIG. 2. In some aspects, the augmented ranked object keywords with regions for all images 616 are provided to an image cropping component 618 (e.g., provided to an image cropping component such as the image cropping component described in FIG. 7, below). In some aspects, the augmented ranked object keywords with regions for all images 616 are provided to an image cropping component 618 using a network, a shared data location, or some other such method including, but not limited to, those described herein.

FIG. 7 is a block diagram 700 showing details of automatic image cropping using object detection, object inference, object augmentation, and object region detection, in accordance with some implementations of the present disclosure. In some configurations, an image cropping component 702 receives a set of augmented ranked object keywords for all images from object image detection and re-ranking component 704. According to some aspects, the image cropping component 702 is an image cropping component such as the image cropping component 222, described in connection with FIG. 2. According to some aspects, the augmented ranked object keywords for all images from object image detection and re-ranking component 704 are augmented ranked object keywords with regions for all images 616 generated by an object region detection and re-ranking component 602, both described herein at least in connection with FIG. 6 and are keywords and regions such as keywords and regions 220, described in connection with FIG. 2.

When the image cropping component 702 receives the augmented ranked object keywords for all images from object image detection and re-ranking component 704, the image cropping component 702 performs operations to crop images for specified aspect ratio(s) including prioritized regions 706 (e.g., using aspect ratios specified in a content brief, as described herein). In some aspects, any acceptable cropping algorithm can be used to perform the final crop based on the prioritized regions corresponding to augmented ranked object keywords for all images from object image detection and re-ranking component 704.

In some aspects, the operations to crop images for specified aspect ratio(s) including prioritized regions 706 generate a set of automatically cropped images 708 (e.g., one or more cropped images for each image in the image corpus, as described herein). In some aspects, the automatically cropped images 708 are provided to a user or device that initiated automatic image cropping (e.g., provided by the automatic image cropping system 104 to the user device 102, both described in connection with FIG. 1). In some aspects, the automatically cropped images 708 are provided to a user or device that initiated automatic image cropping using a network, a shared data location, or some other such method including, but not limited to, those described herein.

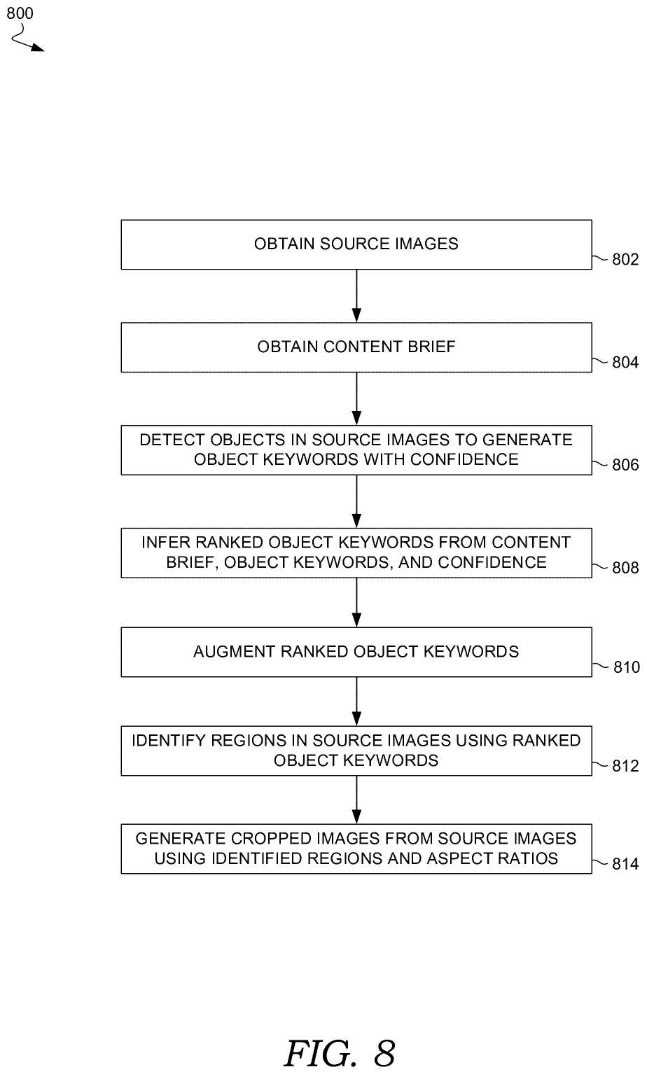

FIG. 8 is a flow diagram 800 illustrating a method for automatically cropping images, in accordance with some implementations of the present disclosure. The method illustrated in FIG. 8 can be performed by, for instance, the automatic image cropping system 104 described herein at least in connection with FIG. 1. Each block of the method illustrated in FIG. 8 and any other methods described herein comprises a computing process performed using any combination of hardware, firmware, and/or software. For instance, various functions can be carried out by a processor executing instructions stored in memory. The method or methods can also be embodied as computer-usable instructions stored on computer storage media. The methods can be provided by a standalone application, a service or hosted service (standalone or in combination with another hosted service), a plug-in to another product, or other such applications, services, products, or plug-ins.

At block 802, source images (e.g., an image corpus) are received by a process or processor performing the method illustrated in FIG. 8. In at least one embodiment, the source images are received from a user device such as user device 102, described herein at least in connection with FIG. 1. In at least one embodiment, the source images that are received from the user device are indicated by using a user interface to specify a location where the source images are stored (e.g., to specify a storage location accessible by the method for automatically cropping images illustrated in FIG. 8). In some configurations, after block 802, the method for automatically cropping images illustrated in FIG. 8 continues at block 804.

At block 804, a content brief is received by a process or processor performing the method illustrated in FIG. 8. In at least one embodiment, the content brief is received from a user device such as user device 102, described herein at least in connection with FIG. 1. In at least one embodiment, the content brief that is received from the user device is indicated using a user interface to specify a location where the content brief is stored (e.g., to specify a storage location accessible by the method for automatically cropping images illustrated in FIG. 8). In some configurations, after block 804, the method for automatically cropping images illustrated in FIG. 8 continues at block 806.

At block 806, operations are performed to detect objects in source images to generate object keywords with confidence. In at least one embodiment, source images obtained at block 802 are used to detect objects in source images to generate object keywords with confidence. In some aspects, operations to detect objects in source images to generate object keywords with confidence are performed by an object detection component (e.g., object detection component 112). In some configurations, after block 806, the method for automatically cropping images illustrated in FIG. 8 continues at block 808.

At block 808, operations are performed to infer ranked object keywords from a content brief, object keywords, and confidence. In at least one embodiment, a content brief obtained at block 804, and object keywords and confidence generated at block 806 are used to infer ranked object keywords. In some aspects, operations to infer ranked object keywords are performed by an object inference component (e.g., object inference component 114). In some configurations, after block 808, the method for automatically cropping images illustrated in FIG. 8 continues at block 810. In some configurations, not shown in FIG. 8, after block 808, the method for automatically cropping images illustrated in FIG. 8 continues at block 812 (e.g., does not perform block 810).

At block 810, operations are performed to augment ranked object keywords. In at least one embodiment, ranked object keywords inferred at block 808 are augmented, as described herein (e.g., by adding, removing, and/or re-ranking ranked object keywords). In some aspects, operations to augment ranked object keywords are performed by an object augmentation component (e.g., object augmentation component 116). In some aspects, not shown in FIG. 8, operations to augment ranked object keywords are not performed (e.g., block 810 is not performed). In some configurations, after block 810 is performed, the method for automatically cropping images illustrated in FIG. 8 continues at block 812.

At block 812, operations are performed to identify regions in source images using ranked object keywords (e.g., ranked object keywords inferred at block 808 or augmented ranked object keywords augmented at block 810). In some aspects, operations to identify regions in source images using ranked object keywords are performed by an object region detection and re-ranking component (e.g., object region detection and re-ranking component 118). In some configurations, after block 812, the method for automatically cropping images illustrated in FIG. 8 continues at block 814.

At block 814, operations are performed to generate cropped images from source images (e.g., source images obtained at block 802) using identified regions (e.g., regions identified at block 812) and aspect ratios (e.g., from a content brief obtained at block 804). In some aspects, operations to generate cropped images are performed by an image cropping component (e.g., image cropping component 120). In some configurations, not shown in FIG. 8, the cropped images generated at block 814 are provided to a user device (e.g., user device 102) for display using a user interface (e.g., user interface 110). In some configurations, not shown in FIG. 8, a location of the cropped images generated at block 814 is provided to a user device (e.g., user device 102) for display using a user interface (e.g., user interface 110). In some configurations, the user device is the same as the user device from which the source images and the content brief are received (e.g., at blocks 802 and 804). In some configurations, the user device is different than the user device from which the source images and the content brief are received. In some configurations, after block 814, the method for automatically cropping images illustrated in block diagram 800 terminates. In some configurations, after block 814, the method for automatically cropping images illustrated in block diagram 800 continues at block 802 to receive new source images.

Although not illustrated in FIG. 8, in some configurations, the operations of the method for automatically cropping source images illustrated in block diagram 800 are performed in a different order than that described. In some configurations, where operations can be performed in a different order, some of the operations can be performed in parallel by a plurality of devices such as those described herein. Similarly, in some configurations, operations can be performed in a batch so that, for example, a plurality of images can be automatically cropped sequentially or in parallel for a single size or aspect ratio, or a single image can be automatically cropped sequentially or in parallel for a plurality of sizes or aspect ratios, or a plurality of images can be automatically cropped sequentially or in parallel for a plurality of sizes or aspect ratios. As an illustrative example, for a single source image and three aspect ratios (e.g., specified in a content brief obtained at block 804), operations from block 806 to block 812 can be performed in parallel for each of the sizes or aspect ratios and for a single image and then block 814 can be performed for each of the three aspect ratios sequentially. As may be contemplates, other orders in which to perform the operations illustrated in block diagram 800 may be considered as within the scope of the present disclosure.

### Exemplary Operating Environment

Having described implementations of the present disclosure, an exemplary operating environment in which embodiments of the present technology can be implemented is described below in order to provide a general context for various aspects of the present disclosure. Referring initially to FIG. 9 in particular, an exemplary operating environment for implementing embodiments of the present technology is shown and designated generally as computing device 900. Computing device 900 is but one example of a suitable computing environment and is not intended to suggest any limitation as to the scope of use or functionality of the technology. Neither should the computing device 900 be interpreted as having any dependency or requirement relating to any one or combination of components illustrated.

The technology can be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The technology can be practiced in a variety of system configurations, including hand-held devices, consumer electronics, general-purpose computers, more specialty computing devices, etc. The technology can also be practiced in distributed computing environments where tasks are performed by remote-processing devices that are linked through a communications network.

With reference to FIG. 9, computing device 900 includes bus 910 that directly or indirectly couples the following devices: memory 912, one or more processors 914, one or more presentation components 916, input/output (I/O) ports 918, input/output components 920, and illustrative power supply 922. Bus 910 represents what can be one or more busses (such as an address bus, data bus, or combination thereof). Although the various blocks of FIG. 9 are shown with lines for the sake of clarity, in reality, delineating various components is not so clear, and metaphorically, the lines would more accurately be grey and fuzzy. For example, one can consider a presentation component such as a display device to be an I/O component. Also, processors have memory. The inventors recognize that such is the nature of the art, and reiterate that the diagram of FIG. 9 is merely illustrative of an exemplary computing device that can be used in connection with one or more embodiments of the present technology. Distinction is not made between such categories as “workstation,” “server,” “laptop,” “hand-held device,” etc., as all are contemplated within the scope of FIG. 9 and reference to “computing device.”

Computing device 900 typically includes a variety of computer-readable media. Computer-readable media can be any available media that can be accessed by computing device 900 and includes both volatile and nonvolatile media, removable and non-removable media. By way of example, and not limitation, computer-readable media can comprise computer storage media and communication media. Computer storage media includes both volatile and nonvolatile, removable and non-removable media implemented in any method or technology for storage of information such as computer-readable instructions, data structures, program modules or other data.

Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 900. The terms “computer storage media” and “computer storage medium” do not comprise signals per se.

Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 912 includes computer storage media in the form of volatile and/or nonvolatile memory. The memory can be removable, non-removable, or a combination thereof. Exemplary hardware devices include solid-state memory, hard drives, optical-disc drives, etc. Computing device 900 includes one or more processors that read data from various entities such as memory 912 or I/O components 920. Presentation component(s) 916 present data indications to a user or other device. Exemplary presentation components include a display device, speaker, printing component, vibrating component, etc.

I/O ports 918 allow computing device 900 to be logically coupled to other devices including I/O components 920, some of which can be built in. Illustrative components include a microphone, joystick, game pad, satellite dish, scanner, printer, wireless device, etc. The I/O components 920 can provide a natural user interface (NUI) that processes air gestures, voice, or other physiological inputs generated by a user. In some instance, inputs can be transmitted to an appropriate network element for further processing. A NUI can implement any combination of speech recognition, touch and stylus recognition, facial recognition, biometric recognition, gesture recognition both on screen and adjacent to the screen, air gestures, head and eye-tracking, and touch recognition associated with displays on the computing device 900. The computing device 900 can be equipped with depth cameras, such as, stereoscopic camera systems, infrared camera systems, RGB camera systems, and combinations of these for gesture detection and recognition. Additionally, the computing device 900 can be equipped with accelerometers or gyroscopes that enable detection of motion.

The present technology has been described in relation to particular embodiments, which are intended in all respects to be illustrative rather than restrictive. Alternative embodiments will become apparent to those of ordinary skill in the art to which the present technology pertains without departing from its scope.

Having identified various components utilized herein, it should be understood that any number of components and arrangements can be employed to achieve the desired functionality within the scope of the present disclosure. For example, the components in the embodiments depicted in the figures are shown with lines for the sake of conceptual clarity. Other arrangements of these and other components can also be implemented. For example, although some components are depicted as single components, many of the elements described herein can be implemented as discrete or distributed components or in conjunction with other components, and in any suitable combination and location. Some elements can be omitted altogether. Moreover, various functions described herein as being performed by one or more entities can be carried out by hardware, firmware, and/or software, as described below. For instance, various functions can be carried out by a processor executing instructions stored in memory. As such, other arrangements and elements (e.g., machines, interfaces, functions, orders, and groupings of functions) can be used in addition to or instead of those shown.

Embodiments described herein can be combined with one or more of the specifically described alternatives. In particular, an embodiment that is claimed can contain a reference, in the alternative, to more than one other embodiment. The embodiment that is claimed can specify a further limitation of the subject matter claimed.

The subject matter of embodiments of the technology is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” can be used herein to connote different elements of methods employed, the terms should not be interpreted as implying any particular order among or between various steps herein disclosed unless and except when the order of individual steps is explicitly described.

For purposes of this disclosure, the word “including” has the same broad meaning as the word “comprising,” and the word “accessing” comprises “receiving,” “referencing,” or “retrieving.” Further, the word “communicating” has the same broad meaning as the word “receiving,” or “transmitting” facilitated by software or hardware-based buses, receivers, or transmitters using communication media described herein. In addition, words such as “a” and “an,” unless otherwise indicated to the contrary, include the plural as well as the singular. Thus, for example, the constraint of “a feature” is satisfied where one or more features are present. Also, the term “or” includes the conjunctive, the disjunctive, and both (a or b thus includes either a or b, as well as a and b).

For purposes of a detailed discussion above, embodiments of the present technology are described with reference to a distributed computing environment; however, the distributed computing environment depicted herein is merely exemplary. Components can be configured for performing novel embodiments of embodiments, where the term “configured for” can refer to “programmed to” perform particular tasks or implement particular abstract data types using code. Further, while embodiments of the present technology can generally refer to the technical solution environment and the schematics described herein, it is understood that the techniques described can be extended to other implementation contexts.

From the foregoing, it will be seen that this technology is one well adapted to attain all the ends and objects set forth above, together with other advantages which are obvious and inherent to the system and method. It will be understood that certain features and subcombinations are of utility and can be employed without reference to other features and subcombinations. This is contemplated by and is within the scope of the claims.

What is claimed is:

1. One or more computer storage media storing computer-useable instructions that, when used by one or more computing devices, cause the one or more computing devices to perform operations, the operations comprising:
obtaining a source image;
obtaining a set of guidelines for cropping the source image;
generating a list of objects present in the source image, using an object
recognition model;
generating a list of desired objects based, at least in part, on the set of guidelines for cropping the source image;
combining the list of objects and the list of desired objects to generate a list of object keywords;
identifying regions of the source image that contain at least one object of the list of objects based, at least in part, on the list of object keywords; and
generating a cropped image from the source image, of a desired image size specified in the set of guidelines, wherein the cropped image at least includes a selected identified region of the identified regions.

2. The one or more computer storage media of claim 1, wherein:
the source image is one of a plurality of images; and
generating the list of objects comprises generating a list of objects that are present in at least one image of the plurality of images, using the object recognition model.

3. The one or more computer storage media of claim 1, wherein the operations further comprise:
assigning a ranking to each of the object keywords of the list of object keywords; and
wherein the selected identified region is selected based, at least in part, on the rankings of the object keywords of objects in the selected identified region.

4. The one or more computer storage media of claim 1, wherein:
the set of guidelines for cropping the source image comprises a content brief that indicates a type of desired content and one or more desired image sizes; and
the list of desired objects is generated using a large-language model (LLM) based, at least in part, on the content brief.

5. The one or more computer storage media of claim 1, wherein the operations further comprise:
augmenting the list of object keywords by removing one or more object keywords from the list of object keywords.

6. The one or more computer storage media of claim 1, wherein the operations further comprise:
augmenting the list of object keywords by adding one or more object keywords to the list of object keywords.

7. The one or more computer storage media of claim 1, wherein the source image is a frame of a video comprising a plurality of frames.

8. The one or more computer storage media of claim 1, wherein combining the list of objects and the list of desired objects to generate a list of object keywords uses a large language model (LLM).

9. The one or more computer storage media of claim 1, wherein identifying regions of the source image that contain at least one object of the list of objects comprises:
segmenting the source image using a segment anything model (SAM) to generate a list of identified regions;
assigning a ranking to the identified regions of the list of identified regions;
combining the list of identified regions and the list of object keywords to generate a list of objects with regions;
sorting the list of objects with regions based, at least in part, on the ranking of the identified regions; and
identifying the regions of the source image that contain at least one object of the list of objects based, at least in part, on the sorted list of objects with regions;.

10. A computer-implemented method comprising:
generating, by an object detection component, a list of objects present in a digital asset selected from a set of digital assets;
generating, by an object inference component, a list of desired objects based, at least in part, on a set of guidelines for cropping digital assets;
combining, by the object inference component, the list of objects and the list of desired objects to generate a list of object keywords;
assigning, by the object inference component, a ranking to each object keyword in the list of object keywords to generate a ranked list of object keywords;
augmenting, by an object augmentation component, the ranked list of object keywords by removing object keywords from the ranked list of object keywords based, at least in part, on the ranking of the object keywords;
identifying, by an object region detection and re-ranking component, regions of the selected digital asset that contain at least one object of the list of objects based, at least in part, on the ranked list of object keywords; and
generating, by an image cropping component, a cropped version of the selected digital asset that at least includes a selected identified region of the identified regions.

11. The computer-implemented method of claim 10, wherein the set of digital assets comprises one or more images.

12. The computer-implemented method of claim 10, wherein the set of digital assets comprises one or more videos.

13. The computer-implemented method of claim 10, wherein the cropped version of the selected digital asset is cropped based, at least in part, on an image size indicated by the set of guidelines for cropping digital assets.

14. The computer-implemented method of claim 10, wherein the cropped version of the selected digital asset is cropped based, at least in part, on an aspect ratio indicated by the set of guidelines for cropping digital assets.

15. The computer-implemented method of claim 10, wherein:
the list of objects comprises a list of objects that are present in at least one digital asset of the set of digital assets; and
each object of the list of objects has an assigned ranking based, at least in part, on a number of occurrences of the object in the set of digital assets.

16. A computer system comprising:
one or more processors; and
one or more computer storage media storing computer-useable instructions that,
when used by the one or more processors, causes the computer system to perform operations comprising:
generating, by an object detection component, a list of objects present in a at least one image of an image corpus;
generating, by an object inference component, a list of desired objects based, at least in part, on a set of guidelines obtained from a content brief;
combining, by the object inference component, the list of objects and the list of desired objects to generate a list of object keywords;
assigning, by the object inference component, a ranking to each object keyword in the list of object keywords to generate a ranked list of object keywords;
identifying, by an object region detection and re-ranking component, regions of a selected image of the image corpus that contain at least one object of the list of objects based, at least in part, on the ranked list of object keywords; and
generating, by an image cropping component, a cropped version of the selected image that at least includes a selected identified region of the identified regions.

17. The computer system of claim 15, wherein the operations further comprise:
augmenting, by an object augmentation component, the ranked list of object keywords by removing one or more object keywords from the list of object keywords based, at least in part, on the assigned ranking.

18. The computer system of claim 15, wherein:
desired objects are assigned ranking that is a positive number; and
restricted objects are assigned a ranking that is a negative number.

19. The computer system of claim 15, wherein generating the list of object keywords uses a large language model (LLM).

20. The computer system of claim 15, wherein the regions of the selected image are identified using a grounded segment anything model that generates a list of identified regions and assigns a ranking to the identified regions of the list of identified regions.
